(19) United States
(12) Patent Application Publication
(10) Pub. No.: US 2024/0352163 A1
(43) Pub. Date: Oct. 24, 2024

(54) Preparation Method for Polytrifluorostyrene

(71) Applicants: Changshu 3F Zhonghao New Chemical Materials Co., Ltd., Jiangsu (CN); Shanghai Huayi 3F New Materials Co., Ltd., Shanghai (CN); Changshu 3F Zhenfu New Materials Co., Ltd., Suzhou, Jiangsu (CN)

(72) Inventors: Lijun DU, Shanghai (CN); Chunting LI, Shanghai (CN); Junyi WU, Shanghai (CN); Libing YUAN, Shanghai (CN)

(21) Appl. No.: 18/684,121

(22) PCT Filed: Oct. 26, 2021
(86) PCT No.: PCT/CN2021/126267

§ 371 Date: Feb. 15, 2024

(30) Foreign Application Priority Data
Aug. 19, 2021 (CN) 202110955545.8

(51) Int. Cl. C08F 112/14

(52) U.S. Cl. CPC C08F 112/20

(57) ABSTRACT

Disclosed is a preparation method for a polytrifluorostyrene. The method comprises: (i) providing a pre-emulsion of a trifluorostyrene monomer and a non-perfluorinated fluorine-containing anionic surfactant, wherein based on the weight of the trifluorostyrene monomer, the amount of the non-perfluorinated fluorine-containing anionic surfactant in the emulsion is 0.1-5 wt %, the non-perfluorinated fluorine-containing anionic surfactant has the general formula: CF₃(CFX)n-(CH₂)m-(C₆H₄)o-M, where n is an integer of 1-7, m is an integer of 1-4, and o is an integer of 0-2; X is selected from —F, —CF₃, —OCF₃, and —FCF₂C(CF₃)₂; and M is selected from a carboxyl group, a sulfo group or respective salts thereof; (ii) adding an initiator to initiate a microemulsion polymerization reaction of the trifluorostyrene monomer; and (iii) adding a coagulant for demulsification.

### TECHNICAL FIELD

The present invention relates to a method for preparing polytrifluorostyrene. The polytrifluorostyrene prepared by the method of the present invention has a high molecular weight or a high glass transition temperature.

### TECHNICAL BACKGROUND

Polytrifluorostyrene is a high melting point amorphous polymer that combines the excellent properties of polytetrafluoroethylene and polystyrene, including not only good heat resistance, low dielectric loss and radiation resistance of polytetrafluoroethylene, but also good solubility of polystyrene. In addition, polytrifluorostyrene is highly transparent, exhibiting excellent optical and light transfer performance. Due to the above unique properties, polytrifluorostyrene has enormous application prospects in fields such as proton exchange membranes, ion exchange membranes, optoelectronic communication, filtering materials, and microelectronics.

Compared with conventional fluorine-containing monomers such as tetrafluoroethylene, hexafluoropropylene, vinylidene fluoride, trifluoromethylene, etc., the hydrogen atoms on the double bond of trifluoromethylene monomer are not only substituted by three fluorine atoms with extremely strong electronegativity, but also by benzene rings with strong conjugation effect. The lone pair electrons on the fluorine atom and the π electrons on the carbon-carbon double bond form a p-π conjugate, and the electron cloud on the benzene ring is conjugated with the electron cloud on the carbon-carbon double bond, which greatly increases the activity of the carbon-carbon double bond. The tension of the double bond is very high, making the homolysis readily to occur. Therefore, although trifluorostyrene has high reactivity, it may easily be subject to cyclization dimerization reaction at room temperature. No matter whether bulk polymerization or solution polymerization is adopted, or no matter what kind of initiator is used, most of the obtained products are dimers and oligomers, rather than high molecular weight polytrifluorostyrene.

In the prior art, the preparation of high molecular weight polytrifluorostyrene was first realized by Prober in 1953 (J. Am. Chem. Soc. 1953, 75, 968-972) through emulsion polymerization. Subsequently, in the US patent U.S. Pat. No. 6,774,150, a hydrocarbon surfactant, dodecylamine hydrochloride, was used as the emulsifier for emulsion polymerization of trifluorostyrene and acrylate monomers with fluorine-containing long side chains, thereby preparing a proton exchange membrane with enhanced mechanical properties and a reduced swelling rate in water. In the US patent U.S. Pat. No. 5,422,411, a hydrocarbon surfactant, dodecylamine hydrochloride was used for emulsion copolymerization of trifluorostyrene and trifluorostyrene with different substituents, thereby preparing solid polymer electrolytes used for preparing electrochemical fuel cells. In Chinese patent CN107254012, a mixture of two anionic surfactants (sodium dodecyl sulfonate and sodium dodecyl sulfate) and a cationic surfactant (sodium dodecylamine hydrochloride) is used as an emulsifier for emulsion polymerization of trifluorostyrene polymers. In Chinese patent CN104245755, a mixture of an anionic surfactant and a cationic surfactant or a non-ionic surfactant is used as an emulsifier for the emulsion copolymerization of trifluorostyrene and other monomers, thereby preparing polymer films and coatings with good performances.

Compared with hydrocarbon surfactants, fluorine-containing surfactants have the following characteristics: extremely high surface activity, low surface tension (15-20 mN/M), low critical micelle concentration, ability to be used below the CMC value with a low dosage; excellent chemical stability, resistance to strong acids, strong bases, and strong oxidants; excellent thermal stability, ability to be used under high-temperature conditions; and good compatibility with fluorine-containing polymers without chain transfer effect during polymerization. Because of the above advantages, fluorine-containing surfactants are very suitable for the emulsion polymerization of trifluorostyrene. However, it is reported (Chem. Abs., 1965, 63 16475) that common fluorine-containing surfactants suitable for emulsion polymerization of fluorine-containing monomers (such as tetrafluoroethylene, vinylidene fluoride, trifluoroethylene, etc.), for example, perfluorinated emulsifiers such as PFOA (perfluorooctanoic acid) cannot be used to obtain polytrifluorostyrene with a high yield and a high molecular weight.

Although the existing emulsion polymerization technology can be used to prepare polytrifluorostyrene with a certain yield, trifluorostyrene is prone to dimerization due to its special monomer structure. When hydrocarbon surfactants are used for emulsion polymerization, due to the high surface tension thereof (30-40 mN/M), a large amount of hydrocarbon emulsifier is added, i.e., 10%-20% of the amount of trifluorostyrene monomer, thus making it difficult to wash in post-treatment and causing serious foaming phenomenon under the presence of a large amount of emulsifiers. The common perfluorinated surfactants used for emulsion polymerization of fluorine-containing monomers have a low surface tension (18-20 mN/M). Although the dosage of the perfluorinated surfactants is very small, i.e., generally less than 1% of the amount of the monomers, they cannot be used for the emulsion polymerization of trifluorostyrene.

Therefore, there is still a need to develop a microemulsion polymerization method from trifluorostyrene, which is required to provide the advantages of a high yield, as well as a high glass transition temperature and a high molecular weight of the polytrifluorostyrene obtained.

### SUMMARY

The purpose of the invention is to provide a microemulsion polymerization method from trifluorostyrene. The method provides a high yield, as well as a high glass transition temperature and a high molecular weight of the polytrifluorostyrene obtained.

Therefore, the present invention relates to a method for preparing polytrifluorostyrene, comprising:
(i) providing a pre-emulsion of a trifluorostyrene monomer and a non-perfluorinated fluorine-containing anionic surfactant, wherein based on the weight of the trifluorostyrene monomer, the amount of the non-perfluorinated fluorine-containing anionic surfactant in the emulsion is 0.1-5 wt %, the non-perfluorinated fluorine-containing anionic surfactant has the following general formula:

CF₃(CFX)n-(CH₂)m-(C₆H₄)o-M
wherein,
n is an integer of 1-7, m is an integer of 1-4, and o is an integer of 0-2;
X is selected from the group consisting of —F, —CF₃, —OCF₃, and —FCF₂C(CF₃)₂;
and M is selected from a carboxyl group, a sulfo group or respective salts thereof;
(ii) adding an initiator to initiate a microemulsion polymerization reaction of the trifluorostyrene monomer; and
(iii) adding a coagulant for demulsification.

The present invention also relates to a use of the following non-perfluorinated fluorine-containing anionic surfactant in the microemulsion polymerization of trifluorostyrene:

CF₃(CFX)n-(CH₂)m-(C₆H₄)o-M
wherein,
n is an integer of 1-7, m is an integer of 1-4, and o is an integer of 0-2;
X is selected from the group consisting of —F, —CF₃, —OCF₃, and —FCF₂C(CF₃)₂;
M is selected from a carboxyl group, a sulfo group or respective salts thereof.

The present invention also relates to a polytrifluorostyrene resin with a glass transition temperature of 205-217° C., a weight average molecular weight of 150-250×10⁴ g/mol, and a microemulsion particle size of 20-60 nm.

### DETAILED DESCRIPTION

The present invention relates to the microemulsion polymerization of trifluorostyrene using a hydrocarbon-containing non-perfluorinated fluorine-containing anionic surfactant. The preparation method of polytrifluorostyrene according to the present invention provides the advantages of a high yield, as well as a high glass transition temperature and a high molecular weight of the product.

1. The microemulsion polymerization method for preparing polytrifluorostyrene with a high glass transition temperature and a high molecular weight according to the present invention includes the step of providing a pre-emulsion of a trifluorostyrene monomer and a non-perfluorinated fluorine-containing anionic surfactant.

The anionic surfactant suitable for the method of the present invention is a surfactant with a main chain containing a hydrocarbon structure such as methylene or benzene ring; a fluorine-containing structure of a straight or branched chain such as a fluorocarbon chain or fluorocarbon ether chain; and an anion such as a carboxylate and a sulfonate, which has the following general formula:

CF₃(CFX)n-(CH₂)m-(C₆H₄)o-M
wherein n is an integer of 1-7, preferably an integer of 1-6, more preferably an integer of 1-5, still more preferably an integer of 1-4, and even more preferably an integer of 1-3;
wherein m is an integer of 1-4, more preferably an integer of 1-3, and still more preferably an integer of 1-2;
is an integer of 0-2, preferably 0 or 1;
X is selected from the group consisting of —F, —CF₃, —OCF₃, and —FCF₂C(CF₃)₂;
M is selected from a carboxyl group, a sulfo group or salts thereof. In a non-limiting example of the present invention, M is selected from the group consisting of —COOH, —SO₃H, —COOK, —COONa, —COONH₄, —SO₃K and —SO₃Na.

Non limiting examples of the non-perfluorinated fluorine-containing anionic surfactant suitable for the method of the present invention include, for example,
CF₃CF₂CF₂CF₂CH₂COOH, CF₃CF₂CF₂CF₂CH₂C₆H₄COOH, CF₃CF₂CF₂CF₂CH₂CH₂COOH, CF₃CF₂CF₂CF₂CH₂CH₂C₆H₄COOH, CF₃CF₂CF₂CF₂(CH₂)₃COOH, CF₃CF₂CF₂CF₂(CH₂)₄COOH, CF₃(CF₂)₅CH₂COOH, CF₃(CF₂)₅CH₂C₆H₄COOH, CF₃(CF₂)₅CH₂CH₂COOH, CF₃(CF₂)₅CH₂CH₂C₆H₄COOH, CF₃(CF₂)₅(CH₂)₄COOH, CF₃CF₂CF₂C(CF₃)₂CH₂COOH, CF₃CF₂CF₂C(CF₃)₂CH₂C₆H₄COOH, CF₃CF₂CF₂C(CF₃)₂(CH₂)₂COOH, CF₃CF₂CF₂C(CF₃)₂(CH₂)₃COOH, CF₃CF₂CF₂C(CF₃)₂(CH₂)₄COOH, CF₃(CF—CF₃)₂CH₂COOH, CF₃(CF—CF₃)₂CH₂C₆H₄COOH, CF₃(CF—CF₃)₂CH₂CH₂COOH, CF₃(CF—CF₃)₂(CH₂)₄COOH, CF3-O—CF(CF3)-CF2-O—CF(CF3)-CH₂COOH, CF₃—O—CF(CF₃)—CF₂—O—CF(CF₃)—CH₂COOH, CF₃—O—CF(CF₃)—CF₂—O—CF(CF₃)—(CH₂)₂COOH, CF₃—O—CF(CF₃)—CF₂—O—CF(CF₃)—(CH₂)₄COOH, CF₃CF₂CF₂CF₂CH₂SO₃H, CF₃CF₂CF₂CF₂CH₂C₆H₄SO₃H, CF₃CF₂CF₂CF₂CH₂CH₂SO₃H, CF₃CF₂CF₂CF₂CH₂CH₂C₆H₄SO₃H, CF₃CF₂CF₂CF₂(CH₂)₃SO₃H, CF₃CF₂CF₂CF₂(CH₂)₄SO₃H, CF₃(CF₂)₅CH₂SO₃H, CF₃(CF₂)₅CH₂C₆H₄SO₃H, CF₃(CF₂)₅CH₂CH₂SO₃H, CF₃(CF₂)₅CH₂CH₂C₆H₄SO₃H, CF₃(CF₂)₅(CH₂)₄SO₃H, CF₃CF₂CF₂C(CF₃)₂CH₂SO₃H, CF₃CF₂CF₂C(CF₃)₂CH₂C₆H₄SO₃H, CF₃CF₂CF₂C(CF₃)₂(CH₂)₂SO₃H, CF₃CF₂CF₂C(CF₃)₂(CH₂)₃SO₃H, CF₃CF₂CF₂C(CF₃)₂(CH₂)₄SO₃H, CF₃(CF—CF₃)₂CH₂SO₃H, CF₃(CF—CF₃)₂CH₂C₆H₄ SO₃H, CF₃(CF—CF₃)₂CH₂CH₂SO₃H, CF₃(CF—CF₃)₂(CH₂)₄SO₃H, CF3-O—CF(CF3)-CF2-O—CF(CF3)-CH₂SO₃H, CF₃—O—CF(CF₃)—CF₂—O—CF(CF₃)—CH₂SO₃H, CF₃—O—CF(CF₃)—CF₂—O—CF(CF₃)—(CH₂)₂SO₃H, CF₃—O—CF(CF₃)—CF₂—O—CF(CF₃)—(CH₂)₄SO₃H, and a sodium salt, a potassium salt, and an ammonium salt of the above-mentioned surfactants or a mixture of two or more thereof in any proportion.

In an example of the present invention, the non-perfluorinated fluorine-containing anionic surfactant is selected from one or more of CF₃CF₂CF₂CF₂CH₂C₆H₄COOH, CF₃CF₂CF₂CF₂(CH₂)₄COOH, CF₃(CF₂)₅CH₂CH₂COOH, CF₃(CF₂)₅CH₂CH₂C₆H₄COOH, CF₃—O—CF(CF₃)—CF₂—O—CF(CF₃)—(CH₂)₄COOH, CF₃CF₂CF₂C(CF₃)₂CH₂C₆H₄COOH, CF₃CF₂CF₂C(CF₃)₂(CH₂)₄COOH, CF₃CF₂CF₂C(CF₃)₂(CH₂)₄COOH, a sodium salt thereof, a potassium salt thereof and an ammonium salt thereof, preferably one or more of CF₃(CF₂)₅CH₂CH₂C₆H₄COOH, CF₃(CF₂)₅CH₂CH₂C₆H₄COOH, CF₃—O—CF(CF₃)—CF₂—O—CF(CF₃)—(CH₂)₄COOH and a sodium salt thereof, a potassium salt thereof and an ammonium salt thereof.

In a example of the present invention, the non-perfluorinated fluorine-containing anionic surfactant is selected from one or more of CF₃(CF₂)₅CH₂C₆H₄SO₃H, CF₃(CF₂)₅CH₂CH₂SO₃H, CF₃CF₂CF₂CF₂CH₂CH₂SO₃H, CF₃—O—CF(CF₃)—CF₂—O—CF(CF₃)—(CH₂)₄SO₃H, CF₃CF₂CF₂C(CF₃)₂(CH₂)₄SO₃H, CF₃(CF—CF₃)₂CH₂SO₃H, CF₃CF₂CF₂CF₂CH₂CH₂SO₃H, CF₃CF₂CF₂C(CF₃)₂CH₂C₆H₄ SO₃H and a sodium salt thereof, a potassium salt thereof and an ammonium salt thereof, preferably one or more of CF₃CF₂CF₂C(CF₃)₂CH₂C₆H₄ SO₃H, CF₃(CF₂)₅CH₂CH₂SO₃H, CF₃—O—CF(CF₃)—CF₂—O—CF(CF₃)—(CH₂)₄SO₃H and a sodium salt thereof, a potassium salt thereof and an ammonium salt thereof.

In an example of the present invention, based on the weight of the trifluorostyrene monomer, the amount of the non-perfluorinated fluorine-containing anionic surfactant in the emulsion is 0.1-5 wt %, preferably 0.2-4 wt %, more preferably 0.3-3 wt %, still more preferably 0.4-2 wt %, even more preferably 0.5-1.5 wt %.

In an example of the present invention, the total amount of the polymeric monomers in the pre-emulsion of the trifluorostyrene monomer and the surfactant is 10-60 wt %, preferably 15-55 wt %, more preferably 20-50 wt %, still more preferably 25-45 wt %, and even more preferably 30-40 wt %.

The method for forming the pre-emulsion of the trifluorostyrene monomer and the non-perfluorinated fluorine-containing anionic surfactant is not particularly limited and may be a conventional method known in the art. In an example of the present invention, said method comprises dissolving a certain amount of a non-perfluorinated fluorine-containing anionic surfactant in a certain amount of deionized water, adding a predetermined proportion of the trifluorostyrene monomer, and stirring for 30 min-60 min in a reactor to obtain a pre-emulsion.

2. The preparation method of the present invention comprises the steps of adding an initiator to initiate a microemulsion polymerization reaction of the trifluorostyrene monomer.

The method of the present invention relates to a microemulsion polymerization, wherein the amount of non-perfluorinated fluorine-containing anionic surfactant is greater than that used for the emulsion polymerization of conventional fluorine-containing monomer (such as tetrafluoroethylene, vinylidene fluoride, trifluoroethylene, etc.), but less than that of a hydrocarbon surfactant used in the conventional trifluorostyrene emulsion polymerization.

The trifluorostyrene microemulsion obtained by the method of the present invention has a particle size of 20-60 nm, preferably 25-55 nm, more preferably 30-50 nm, still more preferably 35-45 nm.

In an example of the present invention, the method of the present invention comprises the step of heating the pre-emulsion after mixing it evenly. The suitable temperature is not particularly limited and may be any temperature suitable for the free radical reaction. In an example of the present invention, the pre-emulsion is heated to 40-70° C., preferably 50-60° C.

The initiator suitable for the method of the present invention is not particularly limited and may be any conventional free radical initiator known in the art. For example, the initiator is an inorganic peroxide initiator, which may be selected from one or more of ammonium persulfate, potassium persulfate, ammonium persulfate/sodium sulfite, and potassium persulfate/sodium sulfite; or an organic initiator, such as one or more of azodiisobutyronitrile, dibenzoyl peroxide and dodecanoyl peroxide; preferably potassium persulfate, ammonium persulfate, or potassium persulfate/sodium bisulfite.

The amount of the initiator is not particularly limited and may be an effective amount for the initiation. In an example of the present invention, the initiator is added in an amount of 0.1-1.5 wt %, preferably 0.5-1 wt %, based on the amount of the trifluorostyrene monomer added.

3. The preparation method of the present invention comprises the steps of adding a coagulant to the microemulsion of polytrifluorostyrene for demulsification, washing, drying and other post-treatment steps.

The coagulant suitable for the method of the present invention is not particularly limited and may be any conventional coagulant in the art. For example, the coagulant may be an acid coagulant, which may be one of dilute nitric acid, dilute sulfuric acid, and dilute hydrochloric acid; or a salt coagulant, such as magnesium chloride, magnesium sulfate, calcium chloride, aluminum chloride, sodium chloride, or potassium aluminum sulfate, preferably dilute nitric acid and sodium chloride.

The amount of the coagulant is not particularly limited and may be an effective amount for demulsification. In an example of the present invention, the coagulant is added in the amount of 1-10 wt %, preferably 2-9 wt %, more preferably 3-8 wt %, still more preferably 4-7 wt %, even more preferably 5-6 wt %, based on the weight of the emulsion of polytrifluorostyrene.

In an example of the present invention, the demulsification involves adding a certain amount of a coagulant and rapidly stirring at a stirring speed greater than 2000-10000 rpm for 1-3 minutes to achieve complete demulsification and separation.

In an example of the present invention, the washing step involves adding a certain amount of deionized water and mixing it with the substance to be washed, stirring at a stirring speed of 1000 rpm for 15 minutes, removing the wash water, and repeating the above steps until the conductivity of the wash water is less than 2μ s/m.

In an example of the present invention, the drying is conducted in a vacuum oven with a vacuum degree of 80-100 kpa at a temperature of 70-80° C. for a drying time of 16-24 h.

In an example of the present invention, the method of the present invention comprises the following steps:
Dissolving a certain amount of a non-perfluorinated fluorine-containing anionic surfactant in deionized water;
Adding a certain amount of a trifluorostyrene monomer to an aqueous solution of the above surfactant, stirring at a certain speed for 30 min˜60 min, thereby forming a pre-emulsion;
Heating the above pre-emulsion to 50˜60° C. after it is mixed evenly;
Formulating a solution with a certain concentration of initiator and adding it to the above pre-emulsion system to initiate the polymerization reaction of trifluorostyrene;
Stirring the above polymerization reaction system at a constant temperature for 10-24 h;
Cooling to room temperature after the polymerization is completed, followed by stopping the stirring;
Adding a certain amount of a coagulant and stirring at high speed until the demulsification and separation of the emulsion of polytrifluorostyrene is completed;
Filtering the polymer after demulsification, washing it with deionized water until the conductivity is qualified;
Drying the polytrifluorostyrene in a vacuum oven after it is thoroughly washed, thereby obtaining the final polytrifluorostyrene.

The present invention also relates to a polytrifluorostyrene resin with a high glass transition temperature and a high molecular weight, wherein the glass transition temperature thereof is 205-217° C., preferably 206-216° C., and more preferably 208-214° C.; the weight average molecular weight thereof is 150-250×10⁴ g/mol, preferably 160-240×10⁴ g/mol, and more preferably 170-230×10⁴ g/mol; and the microemulsion particle size thereof is 20-60 nm, preferably 25-55 nm, and more preferably 30-50 nm.

The polymer yield of the method of the present invention is 92-95 wt %. The polytrifluorostyrene with high glass transition temperature and high molecular weight, as an amorphous polymer, has excellent optical transparency and birefringence properties and thus is particularly suitable for use as an optical film for applications in the fields of optics, electronic devices, etc.

### EXAMPLES

### Test Method

### (1) Determination of the Solids Content in a Polytrifluorostyrene Microemulsion

About 5 g of polymerized polytrifluorostyrene microemulsion was taken and heated at 140° C. for 2 h, and then weighed to calculate the solids content. The experiment was repeated three times and the mean value was calculated.

### (2) Determination of Molecular Weight of Polytrifluorostyrene

About 5 mg of the polymer was weighed and dissolved in 2 mL of HPLC-grade DMF, and its molecular weight was characterized by gel permeation chromatography. The specific test conditions were as follows: DMF containing 0.02 mol/L LiBr, a flow rate of 1 mL/min, a column temperature of 70° C., and a sample concentration of 2.5 mg/mL.

### (3) Determination of Glass Transition Temperature of Polytrifluorostyrene

About 10 mg of the polymer was weighed and placed in a solid crucible, and its glass transition temperature was characterized using a differential scanning calorimeter. The specific test conditions were as follows: a temperature range of 50˜300° C., a nitrogen flow rate of 50 mL/min, and a temperature ramp rate of 10° C./min.

### (4) Determination of the Particle Size of the Polytrifluorostyrene Microemulsion

0.1 uL of the polytrifluorostyrene microemulsion was diluted in 2 mL of deionized water, and its particle size was characterized by a laser particle size analyzer (the disperse phase: water).

### (5) Determination of the Polymer Yield

Polymer yield=(the solids content of the polymer emulsion×the total weight of the emulsion−the weight of the surfactant−the weight of the initiator)/weight of monomers×100%.

### Comparative Example 1

In this comparative example, sodium dodecylamine hydrochloride was used as an emulsifier for emulsion polymerization of trifluorostyrene.

27 g of sodium dodecylamine hydrochloride was weighed and added to a 500 mL reaction vessel. 182 g of deionized water was added and stirred for dissolution. After complete dissolution, 140 g of trifluorostyrene monomer was added and stirring was continued for 45 min to form a pre-emulsion. The temperature of the pre-emulsion was raised to 55° C. 0.54 g of potassium persulfate and 0.28 g of sodium bisulfite were added, and stirring was continued at a constant temperature for 18 h. After the polymerization was completed, the temperature was lowered. After coagulation and demulsification, a polytrifluorostyrene resin was obtained in the form of a white powder after washing and drying.

The performance parameters of the polytrifluorostyrene microemulsion and resin were tested by the above methods. The results are shown in the following table.

### Comparative Example 2

In this comparative example, sodium dodecylamine hydrochloride and sodium dodecyl sulfonate (formulation ratio of 1.5:1) were used as emulsifiers for the emulsion polymerization of trifluorostyrene.

9 g of sodium dodecylamine hydrochloride and 18 g of sodium dodecyl sulfonate were weighed and added to a 500 mL reaction vessel. 182 g of deionized water was added and stirred for dissolution. After complete dissolution, 140 g of trifluorostyrene monomer was added and stirring was continued for 45 min to form a pre-emulsion. The temperature of the pre-emulsion was raised to 55° C. 0.54 g of potassium persulfate and 0.28 g of sodium bisulfite were added, and stirring was continued at a constant temperature for 18 h. After the polymerization was completed, the temperature was lowered. After coagulation and demulsification, a polytrifluorostyrene resin was obtained in the form of a white powder after washing and drying.

The performance parameters of the polytrifluorostyrene microemulsion were tested by the above methods. The results are shown in the following table.

### Comparative Example 3

In this comparative example, sodium perfluorooctanoate was used as an emulsifier. 1.2 g of CF₃(CF₂)₆COONa was weighed and added to a 500 mL reaction vessel. 182 g of deionized water was added and stirred for dissolution. After complete dissolution, 140 g of trifluorostyrene monomer was added and stirring was continued for 45 min to form a pre-emulsion. The temperature of the pre-emulsion was raised to 55° C. 0.54 g of potassium persulfate and 0.28 g of sodium bisulfite were added, and stirring was continued at a constant temperature for 18 h. After the polymerization was completed, the temperature was lowered. After coagulation and demulsification, a polytrifluorostyrene resin was obtained in the form of a white powder after washing and drying.

The performance parameters of the polytrifluorostyrene microemulsion were tested by the above methods. The results are shown in the following table.

### Example 1

In this example, CF₃(CF₂)₅CH₂CH₂SO₃Na was used as an emulsifier for emulsion polymerization of trifluorostyrene.

1.2 g of CF₃(CF₂)₅CH₂CH₂SO₃Na was weighed and added to a 500 mL reaction vessel. 182 g of deionized water was added and stirred for dissolution. After complete dissolution, 140 g of trifluorostyrene monomer was added and stirring was continued for 45 min to form a pre-emulsion. The temperature of the pre-emulsion was raised to 55° C. 0.54 g of potassium persulfate and 0.28 g of sodium bisulfite were added, and stirring was continued at a constant temperature for 18 h. After the polymerization was completed, the temperature was lowered. After coagulation and demulsification, a polytrifluorostyrene resin was obtained in the form of a white powder after washing and drying.

The performance parameters of the polytrifluorostyrene microemulsion were tested by the above methods. The results are shown in the following table.

### Example 2

In this example, CF₃CF₂CF₂C(CF₃)₂CH₂C₆H₄COONa was used as an emulsifier for emulsion polymerization of trifluorostyrene.

1.2 g of CF₃CF₂CF₂C(CF₃)₂CH₂C₆H₄COONa was weighed and added to a 500 mL reaction vessel. 182 g of deionized water was added and stirred for dissolution. After complete dissolution, 140 g of trifluorostyrene monomer was added and stirring was continued for 45 min to form a pre-emulsion. The temperature of the pre-emulsion was raised to 55° C. 0.54 g of potassium persulfate and 0.28 g of sodium bisulfite were added, and stirring was continued at a constant temperature for 18 h. After the polymerization was completed, the temperature was lowered. After coagulation and demulsification, a polytrifluorostyrene resin was obtained in the form of a white powder after washing and drying.

The performance parameters of the polytrifluorostyrene microemulsion were tested by the above methods. The results are shown in the following table.

### Example 3

In this example, CF₃—O—CF(CF₃)—CF₂—O—CF(CF₃)—(CH₂)₄SO₃Na was used as an emulsifier for emulsion polymerization of trifluorostyrene.

1.2 g of CF₃—O—CF(CF₃)—CF₂—O—CF(CF₃)—(CH₂)₄SO₃Na was weighed and added to a 500 mL reaction vessel. 182 g of deionized water was added and stirred for dissolution. After complete dissolution, 140 g of trifluorostyrene monomer was added and stirring was continued for 45 min to form a pre-emulsion. The temperature of the pre-emulsion was raised to 55° C. 0.54 g of potassium persulfate and 0.28 g of sodium bisulfite were added, and stirring was continued at a constant temperature for 18 h. After the polymerization was completed, the temperature was lowered. After coagulation and demulsification, a polytrifluorostyrene resin was obtained in the form of a white powder after washing and drying.

The performance parameters of the polytrifluorostyrene microemulsion were tested by the above methods. The results are shown in the following table.

TABLE 1
Experimental data of the Examples and Comparative Examples

| | | Polymer- | | Weight average | |
|---|---|---|---|---|---|
| | Solids | ization | Particle | molecular | |
| | content | yield | size | weight | Tg |
| No. | (wt %) | (wt %) | (nm) | (10⁴ g/mol) | (° C.) |
| Example 1 | 40.2 | 92.3 | 36 | 203.2 | 214 |
| Example 2 | 39.5 | 90.7 | 42 | 175.3 | 211 |
| Example 3 | 41.5 | 95.1 | 38 | 236.9 | 216 |
| Comparative | 36.4 | 81.4 | 115 | 83.2 | 203 |
| Example 1 | | | | | |
| Comparative | 38.1 | 85.2 | 87 | 102.4 | 205 |
| Example 2 | | | | | |
| Comparative | 5.3 | 12.1 | 217 | 15.2 | 189 |
| Example 3 | | | | | |

The above test results demonstrate that the method of the present invention achieves a high polymerization yield. The polymer is obtained with a high polymerization molecular weight and a high glass transition temperature.

1. A method for preparing polytrifluorostyrene, the method comprising:
(i) providing a pre-emulsion of a trifluorostyrene monomer and a non-perfluorinated fluorine-containing anionic surfactant, wherein based on the weight of the trifluorostyrene monomer, the amount of the non-perfluorinated fluorine-containing anionic surfactant in the emulsion is 0.1-5 wt %, the non-perfluorinated fluorine-containing anionic surfactant has the following general formula:
CF₃(CFX)n-(CH₂)m-(C₆H₄)o-M
wherein,
n is an integer of 1-7, m is an integer of 1-4, and o is an integer of 0-2;
X is selected from the group consisting of —F, —CF₃, —OCF₃, and —FCF₂C(CF₃)₂;
and M is selected from a carboxyl group, a sulfo group or respective salts thereof;
(ii) adding an initiator to initiate a microemulsion polymerization reaction of the trifluorostyrene monomer; and
(iii) adding a coagulant for demulsification.

2. The method according to claim 1, wherein based on the weight of the trifluorostyrene monomer, the amount of the non-perfluorinated fluorine-containing anionic surfactant in the emulsion is 0.1-5 wt %.

3. The method according to claim 1, wherein m is an integer of 1-3, o is 0 or 1; M is selected from the group consisting of —COOH, —SO₃H, —COOK, —COONa, —COONH₄, —SO₃K and —SO₃Na.

4. The method according to claim 1, wherein the non-perfluorinated fluorine-containing anionic surfactant is selected from CF₃CF₂CF₂CF₂CH₂COOH, CF₃CF₂CF₂CF₂CH₂C₆H₄COOH, CF₃CF₂CF₂CF₂CH₂CH₂COOH, CF₃CF₂CF₂CF₂CH₂CH₂C₆H₄COOH, CF₃CF₂CF₂CF₂(CH₂)₃COOH, CF₃CF₂CF₂CF₂(CH₂)₄COOH, CF₃(CF₂)₅CH₂COOH, CF₃(CF₂)₅CH₂C₆H₄COOH, CF₃(CF₂)₅CH₂CH₂COOH, CF₃(CF₂)₅CH₂CH₂C₆H₄COOH, CF₃(CF₂)₅(CH₂)₄COOH, CF₃CF₂CF₂C(CF₃)₂CH₂COOH, CF₃CF₂CF₂C(CF₃)₂CH₂C₆H₄COOH, CF₃CF₂CF₂C(CF₃)₂(CH₂)₂COOH, CF₃CF₂CF₂C(CF₃)₂(CH₂)₃COOH, CF₃CF₂CF₂C(CF₃)₂(CH₂)₄COOH, CF₃(CF—CF₃)₂CH₂COOH, CF₃(CF—CF₃)₂CH₂C₆H₄COOH, CF₃(CF—CF₃)₂CH₂CH₂COOH, CF₃(CF—CF₃)₂(CH₂)₄COOH, CF3-O—CF(CF3)-CF2-O—CF(CF3)-CH₂COOH, CF₃—O—CF(CF₃)—CF₂—O—CF(CF₃)—CH₂COOH, CF₃—O—CF(CF₃)—CF₂—O—CF(CF₃)—(CH₂)₂COOH, CF₃—O—CF(CF₃)—CF₂—O—CF(CF₃)—(CH₂)₄COOH, CF₃CF₂CF₂CF₂CH₂SO₃H, CF₃CF₂CF₂CF₂CH₂C₆H₄SO₃H, CF₃CF₂CF₂CF₂CH₂CH₂SO₃H, CF₃CF₂CF₂CF₂CH₂CH₂C₆H₄SO₃H, CF₃CF₂CF₂CF₂(CH₂)₃SO₃H, CF₃CF₂CF₂CF₂(CH₂)₄SO₃H, CF₃(CF₂)₅CH₂SO₃H, CF₃(CF₂)₅CH₂C₆H₄SO₃H, CF₃(CF₂)₅CH₂CH₂SO₃H, CF₃(CF₂)₅CH₂CH₂C₆H₄SO₃H, CF₃(CF₂)₅(CH₂)₄SO₃H, CF₃CF₂CF₂C(CF₃)₂CH₂SO₃H, CF₃CF₂CF₂C(CF₃)₂CH₂C₆H₄SO₃H, CF₃CF₂CF₂C(CF₃)₂(CH₂)₂SO₃H, CF₃CF₂CF₂C(CF₃)₂(CH₂)₃SO₃H, CF₃CF₂CF₂C(CF₃)₂(CH₂)₄SO₃H, CF₃(CF—CF₃)₂CH₂SO₃H, CF₃(CF—CF₃)₂CH₂C₆H₄ SO₃H, CF₃(CF—CF₃)₂CH₂CH₂SO₃H, CF₃(CF—CF₃)₂(CH₂)₄SO₃H, CF3- O—CF(CF3)-CF2-O—CF(CF3)-CH₂SO₃H, CF₃—O—CF(CF₃)—CF₂—O—CF(CF₃)—CH₂SO₃H, CF₃—O—CF(CF₃)—CF₂—O—CF(CF₃)—(CH₂)₂SO₃H, CF₃—O—CF(CF₃)—CF₂—O—CF(CF₃)—(CH₂)₄SO₃H, and a sodium salt, a potassium salt, and an ammonium salt of the above-mentioned surfactants or a mixture of two or more thereof in any proportion.

5. A method comprising:
using a non-perfluorinated fluorine-containing anionic surfactant in microemulsion polymerization of trifluorostyrene, the non-perfluorinated fluorine-containing anionic surfactant comprising:
CF₃(CFX)n-(CH₂)m-(C₆H₄)o-M
wherein,
n is an integer of 1-7, m is an integer of 1-4, and o is an integer of 0-2;
X is selected from the group consisting of —F, —CF₃, —OCF₃, and —FCF₂C(CF₃)₂;
M is selected from a carboxyl group, a sulfo group or respective salts thereof.

6. The method according to claim 5, wherein m is an integer of 1-3; o is 0 or 1; and M is selected from the group consisting of —COOH, —SO₃H, —COOK, —COONa, —COONH₄, —SO₃K and —SO₃Na.

7. The method according to claim 5, wherein the non-perfluorinated fluorine-containing anionic surfactant is selected from CF₃CF₂CF₂CF₂CH₂COOH, CF₃CF₂CF₂CF₂CH₂C₆H₄COOH, CF₃CF₂CF₂CF₂CH₂CH₂COOH, CF₃CF₂CF₂CF₂CH₂CH₂C₆H₄COOH, CF₃CF₂CF₂CF₂(CH₂)₃COOH, CF₃CF₂CF₂CF₂(CH₂)₄COOH, CF₃(CF₂)₅CH₂COOH, CF₃(CF₂)₅CH₂C₆H₄COOH, CF₃(CF₂)₅CH₂CH₂COOH, CF₃(CF₂)₅CH₂CH₂C₆H₄COOH, CF₃(CF₂)₅(CH₂)₄COOH, CF₃CF₂CF₂C(CF₃)₂CH₂COOH, CF₃CF₂CF₂C(CF₃)₂CH₂C₆H₄COOH, CF₃CF₂CF₂C(CF₃)₂(CH₂)₂COOH, CF₃CF₂CF₂C(CF₃)₂(CH₂)₃COOH, CF₃CF₂CF₂C(CF₃)₂(CH₂)₄COOH, CF₃(CF—CF₃)₂CH₂COOH, CF₃(CF—CF₃)₂CH₂C₆H₄COOH, CF₃(CF—CF₃)₂CH₂CH₂COOH, CF₃(CF—CF₃)₂(CH₂)₄COOH, CF3-O—CF(CF3)-CF2-O—CF(CF3)-CH₂COOH, CF₃—O—CF(CF₃)—CF₂—O—CF(CF₃)—CH₂COOH, CF₃—O—CF(CF₃)—CF₂—O—CF(CF₃)—(CH₂)₂COOH, CF₃—O—CF(CF₃)—CF₂—O—CF(CF₃)—(CH₂)₄COOH, CF₃CF₂CF₂CF₂CH₂SO₃H, CF₃CF₂CF₂CF₂CH₂C₆H₄SO₃H, CF₃CF₂CF₂CF₂CH₂CH₂SO₃H, CF₃CF₂CF₂CF₂CH₂CH₂C₆H₄SO₃H, CF₃CF₂CF₂CF₂(CH₂)₃SO₃H, CF₃CF₂CF₂CF₂(CH₂)₄SO₃H, CF₃(CF₂)₅CH₂SO₃H, CF₃(CF₂)₅CH₂C₆H₄SO₃H, CF₃(CF₂)₅CH₂CH₂SO₃H, CF₃(CF₂)₅CH₂CH₂C₆H₄SO₃H, CF₃(CF₂)₅(CH₂)₄SO₃H, CF₃CF₂CF₂C(CF₃)₂CH₂SO₃H, CF₃CF₂CF₂C(CF₃)₂CH₂C₆H₄SO₃H, CF₃CF₂CF₂C(CF₃)₂(CH₂)₂SO₃H, CF₃CF₂CF₂C(CF₃)₂(CH₂)₃SO₃H, CF₃CF₂CF₂C(CF₃)₂(CH₂)₄SO₃H, CF₃(CF—CF₃)₂CH₂SO₃H, CF₃(CF—CF₃)₂CH₂C₆H₄ SO₃H, CF₃(CF—CF₃)₂CH₂CH₂SO₃H, CF₃(CF—CF₃)₂(CH₂)₄SO₃H, CF3- O—CF(CF3)-CF2-O—CF(CF3)-CH₂SO₃H, CF₃—O—CF(CF₃)—CF₂—O—CF(CF₃)—CH₂SO₃H, CF₃—O—CF(CF₃)—CF₂—O—CF(CF₃)—(CH₂)₂SO₃H, CF₃—O—CF(CF₃)—CF₂—O—CF(CF₃)—(CH₂)₄SO₃H, and a sodium salt, a potassium salt, and an ammonium salt of the above-mentioned surfactants or a mixture of two or more thereof in any proportion.

8. A polytrifluorostyrene resin, wherein the polytrifluorostyrene resin has a glass transition temperature of 205-217° C., a weight average molecular weight of 150-250×10⁴ g/mol, and a microemulsion particle size of 20-60 nm.

9. The polytrifluorostyrene resin according to claim 8, wherein the polytrifluorostyrene resin has a glass transition temperature of 206-216° C.; a weight average molecular weight of 160-240×10⁴ g/mol; and a microemulsion particle size of 30-50 nm.

10. The polytrifluorostyrene resin according to claim 8, wherein the polytrifluorostyrene resin is prepared by the method comprising:
(i) providing a pre-emulsion of a trifluorostyrene monomer and a non-perfluorinated fluorine-containing anionic surfactant, wherein based on the weight of the trifluorostyrene monomer, the amount of the non-perfluorinated fluorine-containing anionic surfactant in the emulsion is 0.1-5 wt %, the non-perfluorinated fluorine-containing anionic surfactant has the following general formula:
CF₃(CFX)n-(CH₂)m-(C₆H₄)o-M
wherein,
n is an integer of 1-7, m is an integer of 1-4, and o is an integer of 0-2;
X is selected from the group consisting of —F, —CF₃, —OCF₃, and —FCF₂C(CF₃)₂;
and M is selected from a carboxyl group, a sulfo group or respective salts thereof;
(ii) adding an initiator to initiate a microemulsion polymerization reaction of the trifluorostyrene monomer; and
(iii) adding a coagulant for demulsification.
